(19) United States
(12) Patent Application Publication
(10) Pub. No.: US 2026/0214563 A1
(43) Pub. Date: Jul. 23, 2026

(54) METHOD AND APPARATUS FOR MANAGING NETWORK SLICE SELECTION ASSISTANCE INFORMATION LIST IN A WIRELESS SYSTEM

(71) Applicant: Samsung Electronics Co., Ltd., Suwon-si, Gyeonggi-do (KR)

(72) Inventors: Koustav ROY, Bangalore (IN); Danish Ehsan HASHMI, Bangalore (IN); Lalith KUMAR, Bangalore (IN); Krishnamurthy D R, Bangalore (IN); Jagadeesh GANDIKOTA, Bangalore (IN); Ashok Kumar NAYAK, Bangalore (IN)

(21) Appl. No.: 19/157,927

(22) PCT Filed: Mar. 21, 2024
(86) PCT No.: PCT/KR2024/003551

§ 371 Date: Aug. 19, 2025

(30) Foreign Application Priority Data
Mar. 27, 2023 (IN) 202341022318
Mar. 13, 2024 (IN) 202341022318

(51) Int. Cl. H04W 48/18; H04W 64/00

(52) U.S. Cl. CPC H04W 48/18; H04W 64/00

(57) ABSTRACT

The disclosure relates to a 5G communication system or a 6G communication system for supporting higher data rates beyond a 4G communication system such as long term evolution (LTE). Embodiments disclosed herein provide a method for managing a NSSAI list in a wireless network (1000) by a UE (100). The method includes receiving the partially allowed NSSAI list or an allowed NSSAI list from a NF entity (200) in the wireless network (1000). Further, the method includes deleting the S-NSSAI, from the partially rejected NSSAI, included in the partially allowed NSSAI list or allowed NSSAI list. Further, the method includes receiving the configured NSSAI information from the NF entity (200). Further, the method includes deleting a stored partially rejected NSSAI based on the configured NSSAI information.

### TECHNICAL FIELD

This disclosure is based on and derives the benefit of Indian Provisional Application 202341022318 filed on 27 Mar. 2023, the contents of which are incorporated herein by reference. The embodiments disclosed herein generally relate to the field of a wireless network, and more particularly, to a User Equipment (UE) and a method to update partially allowed Network Slice Selection Assistance Information (NSSAI) list in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The network slice may be supported in one or more tracking areas (Tas) in a PLMN/SNPN. A partial network slice support in a registration area for a UE includes con-figuring the UE with the partially allowed NSSAI and/or S-NSSAI(s) rejected partially in the RA. The partially allowed NSSAI indicates a Single-Network Slice Selection Assistance Information (S-NSSAIs) values, the UE could use in serving Public Land Mobile Network (PLMN) or Standalone Non-Public Network (SNPN) in some of Tracking Areas (TAs) in current Registration Area (RA). Each S-NSSAI in a partially allowed NSSAI is associated with a list of TAs where the S-NSSAI is supported. Alternatively, the AMF may reject the S-NSSAI(s) with reject cause indicating “partially in the RA”. For each S-NSSAI of the S-NSSAIs rejected partially in the RA the AMF provides a list of TAs where the S-NSSAI is not supported. When creating a registration area for the UEs registering over the 3GPP access and supporting the partial network slice support in the registration area, a Access and Mobility Management Function (AMF) entity may consider the trade-off between signalling for paging in TAs where the S-NSSAI is not supported versus the signalling for mobility registration updates to register with the S-NSSAI in the TA(s) where the S-NSSAI is supported, so that the AMF entity may create a registration area including the TA(s) where the requested S-NSSAI is not supported. For such S-NSSAI the AMF provides either the Partially Allowed NSSAI and the S-NSSAIs rejected partially in the RA. So that, the UE can remain registered in the larger registration area at the same time use the S-NSSAI in sub set of the TAIs where the respective S-NSSAI is supported. Once the list is provided to the UE, there are situations where the UEs subscription or local policy or configurations at the network may change due to which there may be change in one or more the NSSAI lists configure, when such an event occurs how should UE manage with the one or more the NSSAI lists is not defined in prior art. Its desirable to solve such issues.

FIG. 1 is a sequence diagram illustrating a scenario where the UE (100) sending a registration request message without including S-NSSAI-1 in a requested NSSAI list in a wireless network (1000).

At step 1, the UE (100) sends an uplink (UL) Non Access Stratum (NAS) message e.g. registration request message including the S-NSSAI-1 in the requested NSSAI list to a network function (NF) entity (200). At step 2, the network function entity (200) sends a downlink (DL) NAS message e.g. registration accept including the S-NSSAI-1 in partially allowed NSSAI list indicating supported list of TAs as TA-1 and current registration area includes TA-1 and TA-2 to the UE (100). At step 3, the UE (100) moves from the TA-1 to the TA-2. At step 4, the network function entity (200) sends the DL NAS message e.g. UE configuration update command with or without a request to perform the registration procedure for mobility and periodic registration update to the UE (100). The UE configuration includes an allowed NSSAI, a configured NSSAI, a rejected NSSAI, a network slicing subscription change indication, or Network Slice Simultaneous Registration Group (NSSRG) information. At step 5, the UE (100) sends the UL NAS message e.g. UE configuration update complete message to the network function entity (200). At step 6, the UE (100) sends the UL NAS message e.g. registration request message without including the S-NSSAI-1 in requested NSSAI list as the S-NSSAI-1 is in partially allowed NSSAI list of the UE (100) and the UE (100) is outside the tracking area boundary(i.e. in TA-2) and not in TA-1 where it is supported for the S-NSSAI. Thus, the UE cannot use the services on TA-2 though there is possibility of this S-NSSAI may be supported because of change in other NSSAI list UE has received in step 4.

The above information is presented as background information only to help the reader to understand the present invention. Applicants have made no determination and make no assertion as to whether any of the above might be applicable as prior art with regard to the present application.

The principal object of the embodiments herein is to provide a method and a UE for managing a Network Slice Selection Assistance Information (NSSAI) list in a wireless network.

Another object of the embodiments herein is to manage a partially rejected and allowed NSSAI list in the wireless network.

Another object of the embodiments herein is to that whenever a network function entity sends partially allowed NSSAI list to the UE, the UE deletes the S-NSSAIs include in an allowed NSSAI list from the partially rejected NSSAI. That is, the UE starts considering that the respective S-NSSAI is now allowed implicitly without the need to send the partially rejected NSSAI again to the UE.

Another object of the embodiments herein is to that whenever the network function entity sends partially rejected NSSAI list to the UE, the UE deletes S-NSSAIs include in the partially rejected NSSAI list from the partially allowed NSSAI. That is, the UE starts considering that the respective S-NSSAI is now rejected S-NSSAI implicitly without the need to send the partially allowed NSSAI again to the UE.

Another object of the embodiments herein is to that if a new configured NSSAI information is sent to the UE, then the UE deletes the partially rejected NSSAI, because the UE assumes that all the S-NSSAI can be re-used and the UE decides at least to try once on the network. If the network still have restriction then, the network provides the reject cause again/provide partially rejected NSSAI list.

### DISCLOSURE OF INVENTION

### Solution to Problem

Embodiments disclosed herein provide a method for managing a NSSAI list in a wireless network. The method includes receiving, by a UE, a partially allowed NSSAI list or an allowed NSSAI list from a network function (NF) entity in the wireless network. Further, the method includes deleting, by the UE, a Single-Network Slice Selection Assistance Information (S-NSSAI), from a partially rejected NSSAI, included in the partially allowed NSSAI list or the allowed NSSAI list. Further, the method includes receiving, by the UE, a new configured NSSAI information from the NF entity. Further, the method includes deleting, by the UE, a stored partially rejected NSSAI based on the configured NSSAI information.

Embodiments disclosed herein provide a method for managing a NSSAI list in a wireless network. The method includes receiving, by a UE, a partially rejected NSSAI list from a network function (NF) entity in the wireless network. Further, the method includes deleting, by the UE, a S-NSSAI, from a partially allowed NSSAI, included in the partially rejected NSSAI list. Further, the method includes receiving, by the UE, a new configured NSSAI information from the NF entity. Further, the method includes deleting, by the UE, the partially rejected NSSAI based on the configured NSSAI information.

Embodiments disclosed herein provide a UE for managing a NSSAI list in a wireless network. The UE includes a NSSAI list managing controller coupled with a memory and a processor. The NSSAI list managing controller is configured to receive a partially allowed NSSAI list or an allowed NSSAI list from a NF entity in the wireless network. Further, the NSSAI list managing controller is configured to delete a Single-Network Slice Selection Assistance Information (S-NSSAI), from a partially rejected NSSAI, included in the partially allowed NSSAI list and the allowed NSSAI list.

Further, the NSSAI list managing controller is configured to receive a new configured NSSAI information from the NF entity. Further, the NSSAI list managing controller is configured to delete a stored partially rejected NSSAI based on the configured NSSAI information.

Embodiments disclosed herein provide a UE for managing a NSSAI list in a wireless network. The UE includes a NSSAI list managing controller coupled with a memory and a processor. The NSSAI list managing controller is configured to receive a partially rejected NSSAI list from a NF entity in the wireless network. Further, the NSSAI list managing controller is configured to delete a S-NSSAI, from a partially allowed NSSAI, included in the partially rejected NSSAI list. Further, the NSSAI list managing controller is configured to receive a new configured NSSAI information from the NF entity. Further, the NSSAI list managing controller is configured to delete the partially rejected NSSAI based on the configured NSSAI information.

In an embodiment, the partially allowed NSSAI list is received over the UE through a Non Access Stratum (NAS) message. The NAS message is a UE configuration update command message or a registration accept message.

In an embodiment, the UE determines that the UE requests for user plane resources for the PDU session of S-NSSAI or establishment of PDU session on a TAI where the S-NSSAI is supported based on the partially allowed NSSAI list and partially rejected NSSAI list information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The method and UE are illustrated in the accompanying drawings, throughout which like reference letters indicate corresponding parts in the various figures. The embodiments herein will be better understood from the following description with reference to the drawings, in which:

FIG. 1 is a sequence diagram illustrating a scenario of a UE sending a registration request message without including a S-NSSAI-1 in a requested NSSAI list.

FIG. 2 is a sequence diagram illustrating a scenario of the UE deleting S-NSSAI-1 from a partially allowed NSSAI list, according to the embodiments of the disclosure.

FIG. 3 illustrates various hardware components of the UE, according to the embodiments of the disclosure.

FIG. 4 and FIG. 5 are flow charts illustrating a method for managing the NSSAI list in the wireless network, according to the embodiments of the disclosure.

FIG. 6 illustrates a structure of a user equipment (UE), according to the embodiments of the disclosure.

FIG. 7 illustrates a structure of a network entity, according to the embodiments of the disclosure.

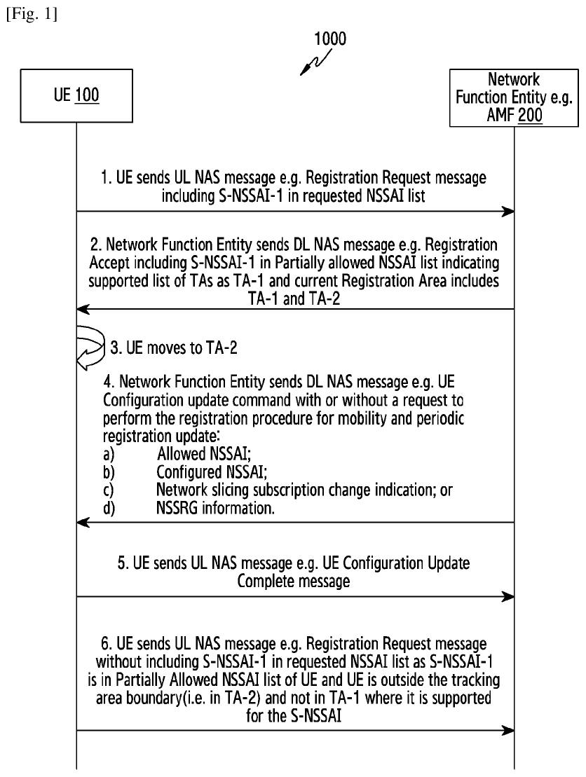

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### Mode for the Invention

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Various embodiments of the disclosure will now be described in detail with reference to the accompanying drawings. In the following description, specific details such as detailed configuration and components are merely provided to assist the overall understanding of these embodiments of the disclosure. Therefore, it should be apparent to those skilled in the art that various changes and modifications of the embodiments described herein can be made without departing from the scope of the disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semi-conductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Embodiments disclosed herein provide a method for managing a NSSAI list in a wireless network. The method includes receiving, by a UE, a partially allowed NSSAI list or an allowed NSSAI list from a NF entity in the wireless network. Further, the method includes deleting, by the UE, a S-NSSAI, from a partially rejected NSSAI, included in the partially allowed NSSAI list and the allowed NSSAI list. Further, the method includes receiving, by the UE, a new configured NSSAI information from the NF entity. Further, the method includes deleting, by the UE, a stored partially rejected NSSAI based on the configured NSSAI information.

The proposed method can be used to assist the UE to implicitly determine the partially allowed NSSAI or partially rejected NSSAI without explicitly signalling from the network function entity of the respective lists. Given the lists are updated earlier based on specific conditions as defined in the proposed method, so that the UE can access the services as early as possible.

The term 5GMM sublayer states in the disclosure are at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIALREGISTRATIONNEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED
5GMM-IDLE mode: In the patent disclosure, when the term is used standalone, a UE in 5GMM-IDLE mode means the UE can be either in 5GMM-IDLE mode over 3GPP access or in 5GMM-IDLE mode over non-3GPP access.
5GMM-CONNECTED mode: In the patent disclosure, when the term is used standalone, a UE in 5GMM-CONNECTED mode means the UE can be either in 5GMM-CONNECTED mode over 3GPP access or in 5GMM-CONNECTED mode over non-3GPP access.
5GMM-IDLE mode over 3GPP access: The UE is in 5GMM-IDLE mode over 3GPP access when no N1 NAS signalling connection between the UE and network over 3GPP access exists. The term 5GMM-IDLE mode over 3GPP access used in the present document corresponds to the term CM-IDLE state for 3GPP access used in 3GPP TS 23.501.
5GMM-CONNECTED mode over 3GPP access: The UE is in 5GMM-CONNECTED mode over 3GPP access when an N1 NAS signalling connection between the UE and network over 3GPP access exists. The term 5GMM-CONNECTED mode over 3GPP access used in the present document corresponds to the term CM-CONNECTED state for 3GPP access used in 3GPP TS 23.501.

In an embodiment, the network slice may be supported in one or more TAs in a PLMN/SNPN. The partial network slice support in a registration area for the UE includes configuring the UE with a partially allowed NSSAI and/or S-NSSAI(s) rejected partially in the RA. When creating a registration area for the UEs registering over the 3GPP access and supporting the partial network slice support in the registration area, a Access and Mobility Management Function (AMF) entity may consider the trade-off between signalling for paging in TAs where the S-NSSAI is not supported versus the signalling for mobility registration updates to register with the S-NSSAI in the TA(s) where the S-NSSAI is supported, so that the AMF entity may create a registration area including the TA(s) where the requested S-NSSAI is not supported. For such S-NSSAI:
1. When requested by the UE from the TA where the S-NSSAI is not supported, then the S-NSSAI is included either in the partially allowed NSSAI or the AMF entity rejects the S-NSSAI partially in the RA.
2. When the S-NSSAI is subject to a NETWORK SLICE ADMISSION CONTROL (NSAC) for maximum number of UEs, then the AMF entity sends the S-NSSAI as rejected partially in the RA.
3. When requested by the UE from a TA where the S-NSSAI is supported, the S-NSSAI is included in the partially allowed NSSAI.
4. When the S-NSSAI is subjected to the NSAC for maximum number of UEs, then the AMF entity restricts the RA so that the S-NSSAI is supported in all the TAs of the RA and includes the S-NSSAI in the allowed NSSAI.

In an embodiment, whether the AMF entity for supporting the UEs uses the partially allowed NSSAI or rejects the S-NSSAIs partially in the RA is a per S-NSSAI decision which is based on an AMF entity local policy. When supported and allowed by the local policy, the partially allowed NSSAI and the S-NSSAIs rejected partially in the RA may be applied simultaneously for the UE for different S-NSSAIs. While the S-NSSAIs of the allowed NSSAI are supported in all the TAs of the registration area, the S-NSSAIs of the partially allowed NSSAI are supported only in the TAs corresponding to the list of TAs (which are subset of the list of TAIs forming the registration area) associated with the S-NSSAI.

In an embodiment, when the UE supports the partial network slice support in the registration area, the AMF entity may create the registration area for the UE considering the support of the S-NSSAIs of the requested NSSAI in the current TA and in the neighbouring TAs and provides to the UE in the registration accept message or in the UE configuration update command message the partially allowed NSSAI or the S-NSSAIs rejected partially in the RA as follows:
1. When one or more of the requested S-NSSAI(s) are supported in the subset of the TAs of the (potential) registration area, the AMF entity may include such S-NSSAI(s) in the partially allowed NSSAI and corresponding mapping information of the S-NSSAI(s) of the partially allowed NSSAI to the Home Public Land Mobile Network (HPLMN) S-NSSAI(s). For each S-NSSAI of the partially allowed NSSAI the AMF entity provides the list of TAs where the S-NSSAI is supported. The UE is considered registered with the S-NSSAI in the whole registration area. The AMF entity also provides the partially allowed NSSAI (without indication of the TA list where the partially allowed S-NSSAIs are supported) to the NG-RAN together with the UE's context.
2. Alternatively, the AMF entity may reject the S-NSSAI(s) with reject cause indicating “partially in the RA”. For each S-NSSAI of the S-NSSAIs rejected partially in the RA the AMF entity provides the list of TAs for which the S-NSSAI is supported or not supported.

In an embodiment, when the UE requests an S-NSSAI in a cell of a TA where the NS-AoS of the S-NSSAI does not match deployed tracking areas, the AMF entity includes the S-NSSAI in the allowed NSSAI or partially allowed NSSAI. When the UE stores partially allowed NSSAI the following applies:
1. The UE is considered registered with the S-NSSAI of the partially allowed NSSAI in the whole registration area. The UE does not trigger registration when moving between the TAs of support and non-support for the S-NSSAI within the RA.
2. The UE is allowed to initiate a protocol data unit (PDU) session establishment for the S-NSSAI only when the UE is in the TA where the S-NSSAI is supported.
3. When the UE has already established a PDU session with the S-NSSAI part of the partially allowed NSSAI, the UE is allowed to activate the user plane resources of the PDU session only when the UE is in the TA part of the list of TAs associated with each S-NSSAI.
4. When the user plane resources are activated for a PDU session to the S-NSSAI part of the partially allowed NSSAI and the UE moves to the TA which is not part of the list of TAs associated with the S-NSSAI, the user plane resources for the PDU session shall be deactivated, but the PDU session context in the UE and a Session Management Function (SMF) entity is not released. The user plane resources for the PDU session shall not be activated as long as the UE is located in the TA which is not part of the list of TAs associated with the S-NSSAI of the partially allowed NSSAI.

When the UE stores the S-NSSAI rejected partially in the RA with the associated list of TAs, the UE is allowed to initiate a mobility registration update procedure to request registration with the S-NSSAI only when the UE is in the TA supporting the S-NSSAI.

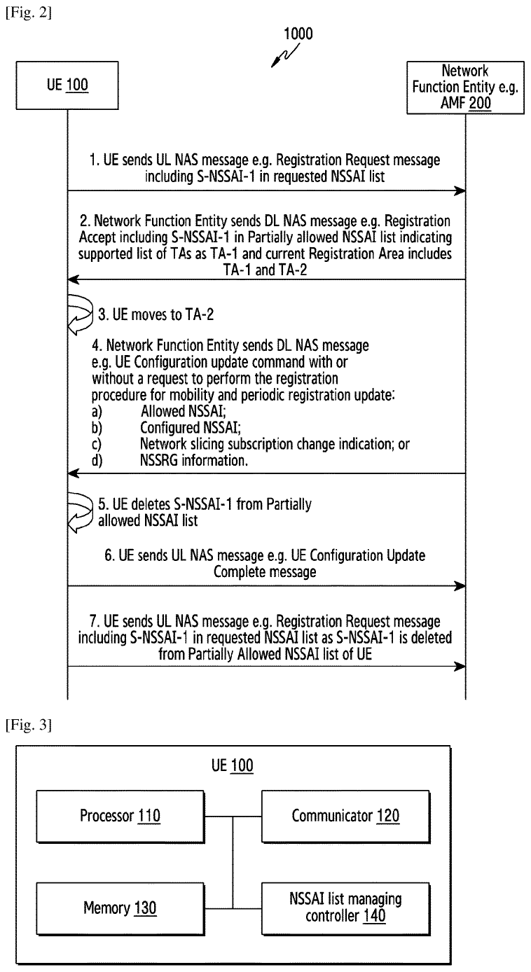

Referring now to the drawings, and more particularly to FIGS. 2 through 5, where similar reference characters denote corresponding features consistently throughout the figures, there are shown at least one embodiment.

FIG. 2 is the sequence diagram illustrating scenario of a UE (100) deleting S-NSSAI-1 from the partially allowed NSSAI list in a wireless network (1000), according to the embodiments as disclosed herein. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IOT) device. The wireless network (1000) can be, for example, but not limited to a fourth generation (4G) network, a fifth generation (5G) network, an Open Radio Access Network (ORAN) or the like.

At step 1, the UE (100) sends the UL NAS message e.g. the registration request message including the S-NSSAI-1 in the requested NSSAI list to the network function entity (200) (e.g., AMF entity or the like). At step 2, in response to the registration request message, the network function entity (200) sends the DL NAS message e.g. registration accept including the S-NSSAI-1 in the partially allowed NSSAI list and/or the S-NSSAIs rejected partially in the RA indicating supported list of TAs as TA-1, not supported list of TA as TA-2 and current registration area includes the TA-1 and the TA-2. At step 3, the UE (100) moves to the TA-2 from the TA-1. At step 4, the network function entity (200) sends the DL NAS message e.g. the UE configuration update command with or without a request to perform the registration procedure for mobility and periodic registration update. The UE configuration update command includes at least one of the below:
a) Allowed NSSAI,
b) Configured NSSAI,
c) Rejected NSSAI,
d) Network slicing subscription change indication,
e) NSSRG information, and
f) default configured NSSAI

At step 5, the UE (100) deletes S-NSSAI-1 from at least one of partially allowed NSSAI list and/or the S-NSSAIs rejected partially in the RA. At step 6, the UE (100) optionally sends the UL NAS message e.g. UE configuration update complete message to the network function entity (200). At step 7, the UE (100) sends UL NAS message e.g. registration request message including S-NSSAI-1 in requested NSSAI list(if required) as S-NSSAI-1 is deleted from partially allowed NSSAI list and/or the S-NSSAIs rejected partially in the RA of the UE (100). The S-NSSAI-1 is deleted from partially allowed NSSAI list and/or the S-NSSAIs rejected partially in the RA implies at least one of: the only value of S-NSSAI-1 is removed from the respective partially allowed NSSAI list/S-NSSAIs rejected partially in the RA or the complete partially allowed NSSAI list/S-NSSAIs rejected partially in the RA is deleted or removed.

The S-NSSAIs rejected partially in the RA is also called as partially rejected NSSAI. In general this S-NSSAIs represent the set of S-NSSAI along with set of TAIs where the respective S-NSSAI is not supported. Similarly partially allowed NSSAI list can be called with any name but this represent the set of the S-NSSAI(s) along with the TAIs where the respective S-NSSAI is supported.

The above flow in FIG. 2 is used only for illustration purpose the respective NSSAI list can be received to the UE in any of the conditions, the invention is applicable when UE receives the respective network slicing information.

Similarly if the UE (100) receives partially allowed NSSAI list/S-NSSAIs rejected partially in the RA in a NAS message like UE configuration update command message or the registration accept message, the UE (100) may delete the respective S-NSSAI which is part of the partially allowed NSSAI list/S-NSSAIs rejected partially in the RA from at least one of the below lists:
a) Allowed NSSAI,
b) Configured NSSAI,
c) Rejected NSSAI,
e) NSSRG information, and
f) default configured NSSAI

In yet another embodiment the UE deletes at least one of the below lists when the UE receives at least one of partially allowed NSSAI list/S-NSSAIs rejected partially in the RA in a NAS message like UE configuration update command message or the registration accept message
a) Allowed NSSAI,
b) Configured NSSAI,
c) Rejected NSSAI,
e) NSSRG information, and
f) default configured NSSAI

If the UE (100) receives the partially allowed NSSAI list, the UE (100) shall remove the respective S-NSSAI part of partially allowed NSSAI list from the S-NSSAIs rejected partially in the RA or delete the S-NSSAIs rejected partially in the RA list.

If the UE (100) receives the S-NSSAIs rejected partially in the RA list, the UE (100) shall remove the respective S-NSSAI part of S-NSSAIs rejected partially in the RA list from the partially allowed NSSAI list or delete the partially allowed NSSAI list.

In an embodiment, the partially allowed NSSAI list and/or the S-NSSAIs rejected partially in the UE (100) performs deleting of S-NSSAI-1 from partially allowed NSSAI list and/or the S-NSSAIs rejected partially in the RA and sends the UL NAS message with registration request message including S-NSSAI-1 in the requested NSSAI list as the S-NSSAI-1 is deleted from partially allowed NSSAI list of the UE (100).

FIG. 3 shows various hardware components of the UE (100), according to the embodiments as disclosed herein. In an embodiment, the UE (100) includes a processor (110), a communicator (120), a memory (130) and a NSSAI list managing controller (140). The processor (110) is coupled with the communicator (120), the memory (130) and the NSSAI list managing controller (140).

In an embodiment, the NSSAI list managing controller (140) receives the partially allowed NSSAI list or the allowed NSSAI list from the NF entity (200). Further, the NSSAI list managing controller (140) deletes the S-NSSAI, from the partially rejected NSSAI, included in the partially allowed NSSAI list or the allowed NSSAI list. Further, the NSSAI list managing controller (140) receives the new configured NSSAI information from the NF entity (200). Based on the new configured NSSAI information, the NSSAI list managing controller (140) deletes the stored partially rejected NSSAI.

Further, the NSSAI list managing controller (140) determines that the UE (100) can request for user plane resources for the PDU session of S-NSSAI or establishment of PDU session on a TAI where the S-NSSAI is supported based on the partially allowed NSSAI list and partially rejected NSSAI list information.

In another embodiment, the NSSAI list managing controller (140) receives the partially rejected NSSAI list from the NF entity (200). Further, the NSSAI list managing controller (140) deletes the S-NSSAI, from the partially allowed NSSAI, included in the partially rejected NSSAI list. Further, the NSSAI list managing controller (140) receives the new configured NSSAI information from the NF entity (200). Based on the new configured NSSAI information, the NSSAI list managing controller (140) deletes the partially rejected NSSAI.

In an embodiment, the partially allowed NSSAI list is received over the NAS message. The DL NAS message is the UE configuration update command message or the or the registration accept message.

The NSSAI list managing controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (140) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

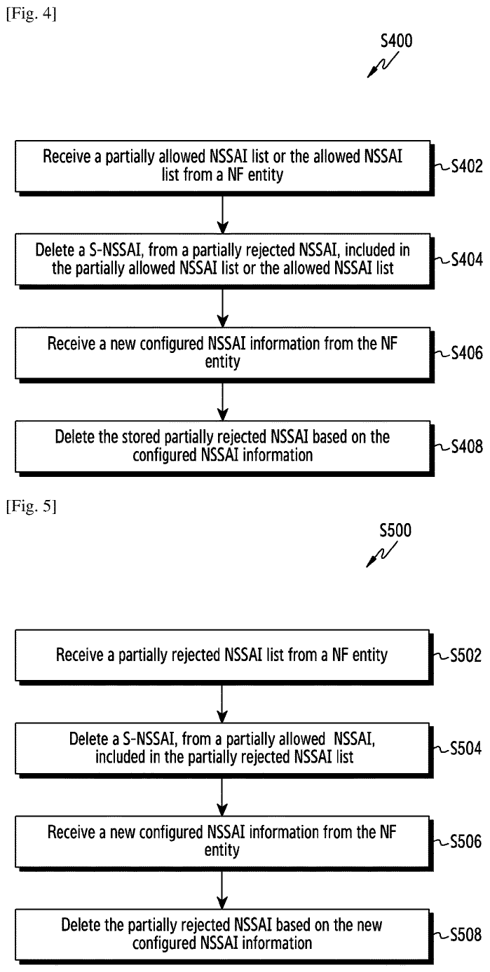

FIG. 4 and FIG. 5 are flow charts (S400 and S500) illustrating a method for managing the NSSAI list in the wireless network (1000), according to the embodiments as disclosed herein.

As shown in FIG. 4, the operations (S402-S408) are handled by the NSSAI list managing controller (140). At S402, the method includes receiving the partially allowed NSSAI list or the allowed NSSAI list from the NF entity (200). At S404, the method includes deleting the S-NSSAI, from the partially rejected NSSAI, included in the partially allowed NSSAI list or the allowed NSSAI list. At S406, the method includes receiving the new configured NSSAI information from the NF entity (200). At S408, the method includes deleting the stored partially rejected NSSAI based on the new configured NSSAI information.

As shown in FIG. 5, the operations (S502-S508) are handled by the NSSAI list managing controller (140). At S502, the method includes receiving the partially rejected NSSAI list from the NF entity (200). At S504, the method includes deleting the S-NSSAI, from the partially allowed NSSAI, included in the partially rejected NSSAI list. At S506, the method includes receiving the new configured NSSAI information from the NF entity (200). At S508, the method includes deleting the partially rejected NSSAI based on the new configured NSSAI information.

The proposed method can be used to assist the UE (100) to implicitly determine the partially allowed NSSAI or partially rejected NSSAI without explicitly signalling from the network function entity of the respective lists. Given the lists are updated earlier based on specific conditions as defined in the proposed method, so that the UE (100) can access the services as early as possible.

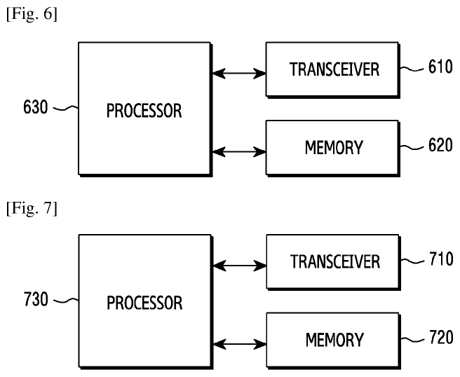

FIG. 6 illustrates a structure of a UE according to an embodiment of the disclosure.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor. Furthermore, the UE of FIG. 6 corresponds to the UE of the FIG. 3.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

FIG. 7 illustrates a structure of a network entity, according to the embodiments of the disclosure.

Referring to FIG. 7, the network entity includes a transceiver (710), a memory (720), and a processor (730). The transceiver (710), the memory (720), and the processor (730) of the network entity may operate according to a communication method of the network entity described above. However, the components of the terminal are not limited thereto. For example, the network entity may include fewer or a greater number of components than those described above. In addition, the processor (730), the transceiver (710), and the memory (720) may be implemented as a single chip. Also, the processor (730) may include at least one processor.

The network entity includes at least one entity of a core network. For example, the network entity includes an Access and mobility management function (AMF), a session management function (SMF), a policy control function (PCF), a network repository function (NRF), a user plane function (UPF), a network slicing selection function (NSSF), an authentication server function (AUSF), a unified data management (UDM) and a network exposure function (NEF), but the network entity is not limited thereto. For example, the network entity corresponds to a user equipment (UE) or a base station (BS).

The transceiver (710) collectively refers to a network entity receiver and a network entity transmitter, and may transmit/receive a signal to/from a base station or a UE. The signal transmitted or received to or from the base station or the UE may include control information and data. In this regard, the transceiver (710) may include an RF transmitter for up-converting and amplifying a frequency of a transmitted signal, and an RF receiver for amplifying low-noise and down-converting a frequency of a received signal. However, this is only an example of the transceiver (710) and components of the transceiver (710) are not limited to the RF transmitter and the RF receiver.

The transceiver (710) may receive and output, to the processor (730), a signal through a wireless channel, and transmit a signal output from the processor (730) through the wireless channel.

The memory (720) may store a program and data required for operations of the network entity. Also, the memory (720) may store control information or data included in a signal obtained by the network entity. The memory (720) may be a storage medium, such as a ROM, a RAM, a hard disk, a CD-ROM, and a DVD, or a combination of storage media.

The processor (730) may control a series of processes such that the network entity operates as described above. For example, the transceiver (710) may receive a data signal including a control signal, and the processor (730) may determine a result of receiving the data signal.

Please note that the EPS in the patent disclosure can also be referred to S1-mode or E-UTRAN or LTE system. The 5GS in the patent disclosure can also be referred to N1-mode or NR or NG-RAN or 5G.

The various actions, acts, blocks, steps, or the like in the flow charts (S600 and S700) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless communication system, the method comprising:
receiving, from a network function (NF) entity, at least one of configured network slice selection assistance information (NSSAI), allowed NSSAI, or rejected NSSAI, wherein each of the at least one of the configured NSSAI, the allowed NSSAI, or the rejected NSSAI includes a single-NSSAI (S-NSSAI); and
deleting the S-NSSAI from at least one of partially rejected NSSAI or partially allowed NSSAI.

2. The method of claim 1, wherein, in case that the UE receives the S-NSSAI included in the configured NSSAI or the allowed NSSAI, the S-NSSAI is deleted from the partially rejected NSSAI.

3. The method of claim 1,
wherein, in case that the UE receives the S-NSSAI included in the rejected NSSAI, the S-NSSAI is deleted from the partially allowed NSSAI.

4. The method of claim 1,
wherein the network function entity is an access and mobility management function (AMF) entity.

5. The method of claim 4, further comprising:
transmitting, to the AMF entity, a registration request message including a requested NSSAI list, wherein the requested NSSAI list includes the S-NSSAI.

6. A method performed by a network function (NF) entity in a wireless communication system, the method comprising:
transmitting, to a user equipment (UE), at least one of configured network slice selection assistance information (NSSAI), allowed NSSAI, or rejected NSSAI, wherein each of the at least one of the configured NSSAI, the allowed NSSAI, or the rejected NSSAI includes a single-NSSAI (S-NSSAI), and
wherein the S-NSSAI is deleted from at least one of partially rejected NSSAI or partially allowed NSSAI.

7. The method of claim 6,
wherein, in case that the S-NSSAI is included in the configured NSSAI or the allowed NSSAI, the S-NSSAI is deleted from the partially rejected NSSAI, and
wherein, in case that the S-NSSAI is included in the rejected NSSAI, the S-NSSAI is deleted from the partially allowed NSSAI.

8. The method of claim 6,
receiving, from the UE, a registration request message including a requested NSSAI list, wherein the requested NSSAI list includes the S-NSSAI,
wherein the NF entity is an access and mobility management function (AMF) entity.

9. A user equipment (UE) in a wireless communication system, the UE comprising:
a transceiver; and
a controller coupled with the transceiver and configured to:
receive, from a network function (NF) entity, at least one of configured network slice selection assistance information (NSSAI), allowed NSSAI, or rejected NSSAI, wherein each of the at least one of the configured NSSAI, the allowed NSSAI, or the rejected NSSAI includes a single-NSSAI (S-NSSAI); and
delete the S-NSSAI from at least one of partially rejected NSSAI or partially allowed NSSAI.

10. The UE of claim 9,
wherein, in case that the UE receives the S-NSSAI included in the configured NSSAI or the allowed NSSAI, the S-NSSAI is deleted from the partially rejected NSSAI.

11. The UE of claim 9,
wherein, in case that the UE receives the S-NSSAI included in the rejected NSSAI, the S-NSSAI is deleted from the partially allowed NSSAI.

12. The UE of claim 9,
wherein the network function entity is an access and mobility management function (AMF) entity.

13. The UE of claim 12, wherein the controller is further configured to:
transmit, to the AMF entity, a registration request message including a requested NSSAI list, wherein the requested NSSAI list includes the S-NSSAI.

14. A network function (NF) entity in a wireless communication system, the NF entity comprising:
a transceiver; and
a controller coupled with the transceiver and configured to:
transmit, to a user equipment (UE), at least one of configured network slice selection assistance information (NSSAI), allowed NSSAI, or rejected NSSAI, wherein each of the at least one of the configured NSSAI, the allowed NSSAI, or the rejected NSSAI includes a single-NSSAI (S-NSSAI), and
wherein the S-NSSAI is deleted from at least one of partially rejected NSSAI or partially allowed NSSAI.

15. The NF entity of claim 14, wherein the controller is further configured to:
receive, from the UE, a registration request message including a requested NSSAI list, and
wherein the requested NSSAI list includes the S-NSSAI,
wherein, in case that the S-NSSAI is included in the configured NSSAI or the allowed NSSAI, the S-NSSAI is deleted from the partially rejected NSSAI,
wherein, in case that the S-NSSAI is included in the rejected NSSAI, the S-NSSAI is deleted from the partially allowed NSSAI, and
wherein the NF entity is an access and mobility management function (AMF) entity.
